(19) United States
(12) Patent Application Publication
(10) Pub. No.: US 2018/0184161 A1
(43) Pub. Date: Jun. 28, 2018

(54) METHOD AND SYSTEM FOR SET-TOP BOX PLATFORM TRANSITIONS

(71) Applicant: ARRIS Enterprises LLC, Suwanee, GA (US)

(72) Inventors: Sundar Murthy Tumuluru, Bangalore (IN); Surya Prakash Mahaswaram, Miyapur (IN)

(21) Appl. No.: 15/392,562

(22) Filed: Dec. 28, 2016

(51) Int. Cl. H04N 21/443; G06F 17/30; H04N 21/434; H04N 21/854

(52) U.S. Cl. CPC H04N 21/4435; H04N 21/85406; H04N 21/434; G06F 17/30076

(57) ABSTRACT

In an embodiment, a method for transitioning a set-top box from one platform to another is disclosed. In an embodiment, the method involves extracting provisioning parameters from a source platform file system, recording provisioning information to memory allocated to the common boot loader space, wherein the provisioning information comprises at least one of a reference pointer to the extracted provisioning parameters and the extracted provisioning parameters, transitioning from the source platform file system to a target platform file system, and populating provisioning parameters in the target platform file system using the provisioning to information stored in the memory allocated to the common boot loader.

### FIELD OF THE INVENTION

The invention related to media devices. More specifically, the invention relates to transitioning a set-top box from one platform to another platform.

### BACKGROUND

Modern broadcast television network systems often employ a set-top box that operates as a tuner to turn a source signal into a form that can be output to a television screen or other display device. Typically, a set-top box is configured to decode source signals and to support various services such as electronic program guides. To decode source signals and to support the various services, a software platform is loaded onto the set-top box to allow for user interaction with the set-top box. When a new software platform is released, the new software platform can be deployed to the set-top box in the broadcast television network system as a software upgrade.

### SUMMARY

In an embodiment, a method for transitioning a set-top box from one platform to another is disclosed. In an embodiment, the method involves extracting provisioning parameters from a source platform file system, recording provisioning information to memory allocated to the common boot loader, wherein the provisioning information comprises at least one of a reference pointer to the extracted provisioning parameters and the extracted provisioning parameters, transitioning from the source platform file system to a target platform file system, and populating provisioning parameters in the target platform file system using the provisioning information stored in the memory allocated to the common boot loader.

In a second embodiment, prior to extracting provisioning parameters, the method further involves upgrading a start loader of a common boot loader to include a transition component, the transition component configured to perform the extracting and recording.

In another embodiment, the start loader is further upgraded with a module that allows the start loader to understand the source platform file system.

In another embodiment, the transition component is configured with locations of provisioning parameters in the source platform file system and is configured to understand data structure formats of the source platform file system.

In another embodiment, the locations of provisioning parameters are identified by offsets.

In another embodiment, the extracted provisioning parameters are recorded in raw format.

In another embodiment, populating provisioning parameters comprises formatting provisioning parameters into the format of the target platform file system.

In another embodiment, transitioning comprises reformatting the source platform file system to the target platform file system.

In another embodiment, if the provisioning information comprises a reference pointer to the extracted provisioning parameters, then provisioning parameters in the target platform file system are populated with the extracted provisioning parameters stored at a memory location indicated by the reference pointer.

In another embodiment, the memory location indicated by the reference pointer is a memory location in at least one of a portion of non-volatile memory reserved for writing provisioning parameters, a wide area network (WAN) storage location, and a local area network (LAN) storage location, wherein the reserved memory is preserved when transitioning from the source platform file system to the target platform file system.

In another embodiment, a non-transitory computer-readable storage medium comprising instructions is disclosed. In an embodiment, when the instructions are executed in a computing device, the instructions cause the computing device to carry out steps for transitioning a set-top box from one platform to another platform, the steps comprising extracting provisioning parameters from a source platform file system, recording provisioning information to memory allocated to a common boot loader space, wherein the provisioning information comprises at least one of a reference pointer to the extracted provisioning parameters and the extracted provisioning parameters, transitioning from the source platform file system to a target platform file system, and populating provisioning parameters in the target platform file system using the provisioning information stored in the memory allocated to the common boot loader space.

In another embodiment, prior to extracting provisioning parameters, a further step is carried out, the step comprising upgrading a start loader of a common boot loader to include a transition component, the transition component configured to perform the extracting and recording.

In another embodiment, prior to extracting provisioning parameters, upgrading the start loader with a module that allows the start loader to understand the source platform file system.

In another embodiment, the transition component is configured with locations of provisioning parameters in the source platform file system and is configured to understand data structure formats of the source platform file system.

In another embodiment, the locations of provisioning parameters are identified by offsets.

In another embodiment, the extracted provisioning parameters are recorded in raw format.

In another embodiment, populating provisioning parameters comprises formatting provisioning parameters into the format of the target platform file system.

In another embodiment, transitioning comprises reformatting the source platform file system to the target platform file system.

In another embodiment, a set-top box comprising a processor and memory is disclosed. In the embodiment the memory comprises instructions that, when executed by the processor, perform steps comprising extracting provisioning parameters from a source platform file system, recording provisioning information to memory allocated to a common boot loader space, wherein the provisioning information comprises at least one of a reference pointer to the extracted provisioning parameters and the extracted provisioning parameters, transitioning from the source platform file system to a target platform file system, and populating provisioning parameters in the target platform file system using the provisioning information stored in the memory allocated to the common boot loader space.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a broadcast television network system.

FIG. 2 depicts a set-top box.

FIG. 3 depicts elements within storage of a set-top box.

FIGS. 4A and 4B illustrate upgrading a start loader in a common boot loader of a set-top box in accordance with an embodiment of the invention.

FIG. 5 is a flow chart diagram of a technique for extracting and recording provisioning parameters from a source platform file system using a transition component of a common boot loader in accordance with an embodiment of the invention.

FIGS. 6A-6C illustrate a technique of extracting and recording provisioning parameters from a source platform file system using a transition component in an upgraded start loader of the common boot loader in accordance with an embodiment of the invention.

FIG. 7 is a flow chart diagram of a technique for populating provisioning parameters in the target platform file system in accordance with an embodiment of the invention.

FIGS. 8A-8C illustrate populating provisioning parameters in the target platform file system in accordance with an embodiment of the invention.

FIG. 9 illustrates the state of the storage of a set-top box after a clean-up operation in accordance with an embodiment of the invention.

FIG. 10 is a flow chart diagram of a technique for transitioning a set-top box from one platform to another in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing to from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

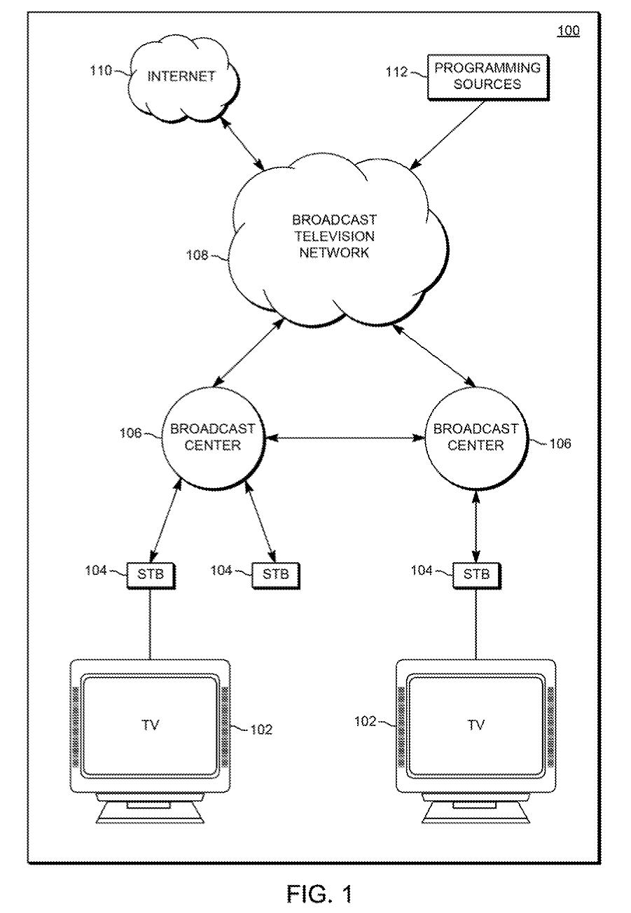

FIG. 1 depicts a broadcast television network system 100. The broadcast television network system includes televisions 102 or other external display devices (not shown), each connected to a set-top box 104. The set-top boxes are further connected to a broadcast center 106, which in turn is connected to a broadcast television network 108. The broadcast television network is connected to the Internet 110 as well as to programming sources 112.

In an embodiment, a television connects to a set-top box and the set-top box is configured to run a software platform (e.g., Thin Client, KreaTV for Americas, Reference Design Kit, Moxi, or any other platform) that facilitates features such as electronic programming guides, favorites, timers, DVR functionality, and channel access credentials. The set-top box software platform can be upgraded to provide a more robust feature set or it can be transitioned to a different software platform if, for example, a decision is made to terminate support of the current software platform. Upgraded software platforms can be received by the set-top box via a broadcast center.

In the context of a cable network, the broadcast center 106 may take the form of a head-end. A head-end is generally a centrally-located facility within a community where cable television programming is received from programming sources and packaged together for cable transmission to customer homes. The programming sources 112 provide content to the broadcast centers from content providers (e.g., CNN, ESPN, HBO, TBS, etc.) over the broadcast television network via satellite, fiber optic cable, and/or special digital tape. The broadcast television network may be embodied as a cable television network or a direct broadcast satellite (DBS) network, although other networks are within the scope of the invention.

In alternative embodiments, broadcast centers and set-top boxes may be interconnected via a separate network, such as a wide area network (WAN), the Internet, or a local area network (LAN), in addition to the direct connections and connectivity through the broadcast television network.

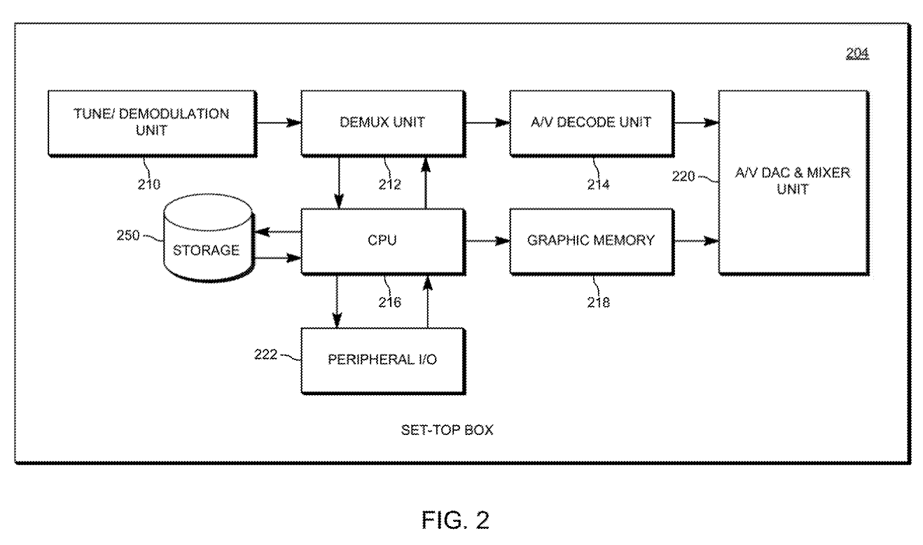

FIG. 2 depicts a set-top box 204. The set-top box may include a tune/demodulation unit 210, a demux unit 212, an audio/video (A/V) decode unit 214, storage 250, a central processing unit or processor (CPU) 216, a graphic memory 218, an audio/video (AN) digital-to-analog converter (DAC) and mixer unit 220, and a peripheral input/output (I/O) 222, but other set-top box configurations are envisioned as well.

The tune/demodulation unit 210 can be configured for tuning or demodulating program transport streams received by the set-top box from a broadcast center, which can be forwarded to the demux unit 212 for demultiplexing the desired transport stream of the selected frequency. The demultiplexed transport streams can be forwarded to the A/V decode unit 214 for decoding and to the A/V DAC and mixer unit 220 for conversion. The resultant decoded streams can be forwarded to a display device via the peripheral I/O 222 and/or can be stored in the storage 250.

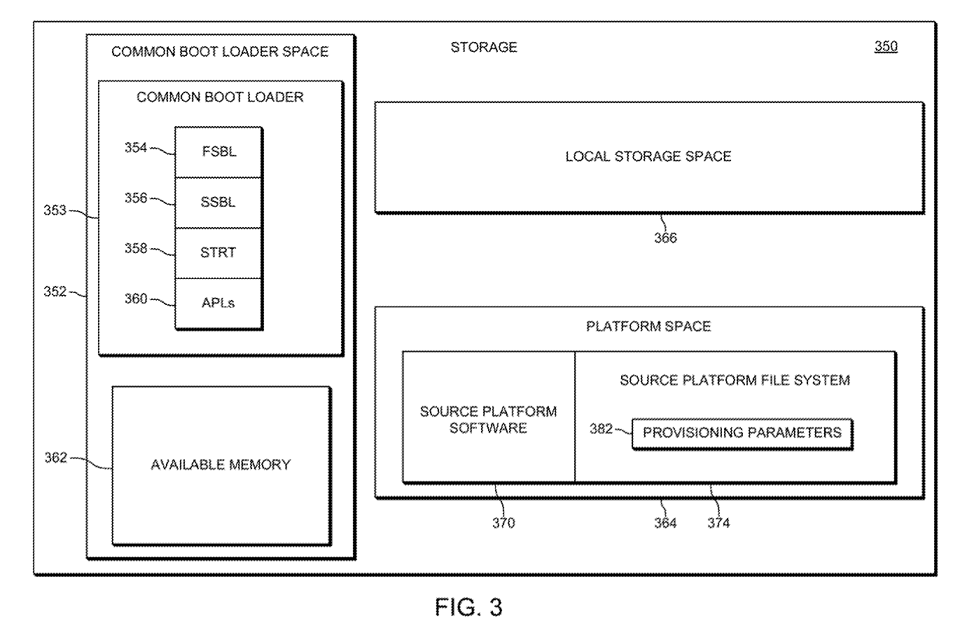

FIG. 3 depicts elements within storage 350 of a set-top box. The storage may include several types of memory, such as non-volatile flash memory and hard disk drives, or may include a single uniform type of memory. In the example embodiment of FIG. 3, the memory is allocated to a common boot loader space 352, a platform space 364, and a local storage space 366. The local storage space can be used, for example, to store recorded programming or additional content received by the set-top box. The common boot loader space can be used to store a common boot loader 353 and memory allocated to the common boot loader space, but not used by the common boot loader can be referred to as available memory 362. In an embodiment, the common boot loader includes non-upgradable components, such as a first stage boot loader 354 (FSBL) and a second stage boot loader (SSBL) 356, and upgradable components, such as a start loader (STRT) 358 and application programming interfaces (APIs) 360. In an embodiment, non-upgradable components may not be capable of recovery or restoration should an error occur during the upgrade of the component. For example, the FSBL is typically only a few lines of code and executes before an operating system has been initialized. Thus, the capacity to reload the FSBL should an error occur may not be available. Alternatively, upgradable components are initialized by the boot loader at a point when the capacity to recover or restore the components is available. Identifying some components of the common boot loader as non-upgradable provides a compromise between robustness and flexibility by reducing the chance of total failure of the set-top box, while allowing some components to be upgraded. A boot loader, such as the common boot loader, is a small computer program that initializes a larger program such as, for example, an operating system. The boot loader is typically stored in a persistent memory location. For example, the common boot loader is stored in the common boot loader space and, in the event of a power failure or data corruption of the platform space or the local storage space, the common boot loader space will persist allowing the common boot loader to continue functioning. The platform space stores platform software and a platform file system to implement a platform. The platform file system is formatted to use data structure formats of the platform. In FIG. 3, the platform space stores source platform software 370 and a source platform file system 374 used by the source platform software to store, for example, provisioning parameters 382. In an embodiment, provisioning parameters include a virtual channel table ID (VCT-ID), a virtual channel table (VCT), a modulation mode table (MMT), a carrier definition table (CDT), a connection state, user preferences, and parental control settings as well as other operational parameters used to enable a smooth platform transition. The provisioning parameters can be received from a head-end (e.g., the broadcast center) or can be entered manually by a user of the set-top box (not shown). For example, the platform software may include features such as a program guide, a user-selected list of favorites, and parental locks, which require additional provisioning parameters for operation. In the event a provisioning parameter is deleted, a provisioning parameter received from the head-end can be restored after a refresh signal is received from the head-end. However, a deleted user-entered provisioning parameter may not be recoverable.

In operation, the common boot loader executes the first stage boot loader, the second stage boot loader, and the start loader to initialize the source platform software and the source platform file system stored in the platform space, and a user can interact with the source platform software to access recordings and content stored in the local storage space. If the platform is upgraded from a source platform to a target platform and the source platform uses a different platform file system than the target platform, then formatting the platform file system to use data structure formats of the target platform may be required before the upgrade is performed. When the platform file system is reformatted, data stored in the platform file system is erased or deleted. Thus, if the source platform uses a different file system than the target platform and a reformat is required as part of an upgrade, the stored provisioning parameters will be erased or deleted and the upgraded platform may be rendered inactive until a refresh signal is received from the head-end and provisioning parameters can be restored. Additionally, user-entered provisioning parameters may need to be reentered. The delay in waiting for a refresh signal to restore provisioning parameters or the repetitive effort of recreating user-entered provisioning parameters may degrade the user experience.

In accordance with an embodiment of the invention, a method for transitioning a set-top box from one platform to another is disclosed. In an embodiment, the method involves extracting provisioning parameters from a source platform file system, recording provisioning information to memory allocated to the common boot loader space, wherein the provisioning information comprises at least one of a reference pointer to the extracted provisioning parameters and the extracted provisioning parameters, transitioning from the source platform file system to a target platform file system, and populating provisioning parameters in the target platform file system using the provisioning information stored in the memory allocated to the common boot loader space. Typically, the memory allocated to the common boot loader space is persistent memory that is not impacted or erased during a platform transition. Thus, by extracting provisioning parameters and storing the provisioning parameters (or a pointer to the provisioning parameters) in the common boot loader space, provisioning parameters persist through a platform transition and may not need to be refreshed from a head end and/or reentered manually by a user.

In accordance with a further embodiment of the invention, a start loader of the common boot loader is upgraded to include a transition component that performs the extracting and recording of provisioning parameters. By upgrading the start loader, additional components (e.g., additional hardware) may not be required by the common boot loader to implement the extracting, storing, and populating functionality.

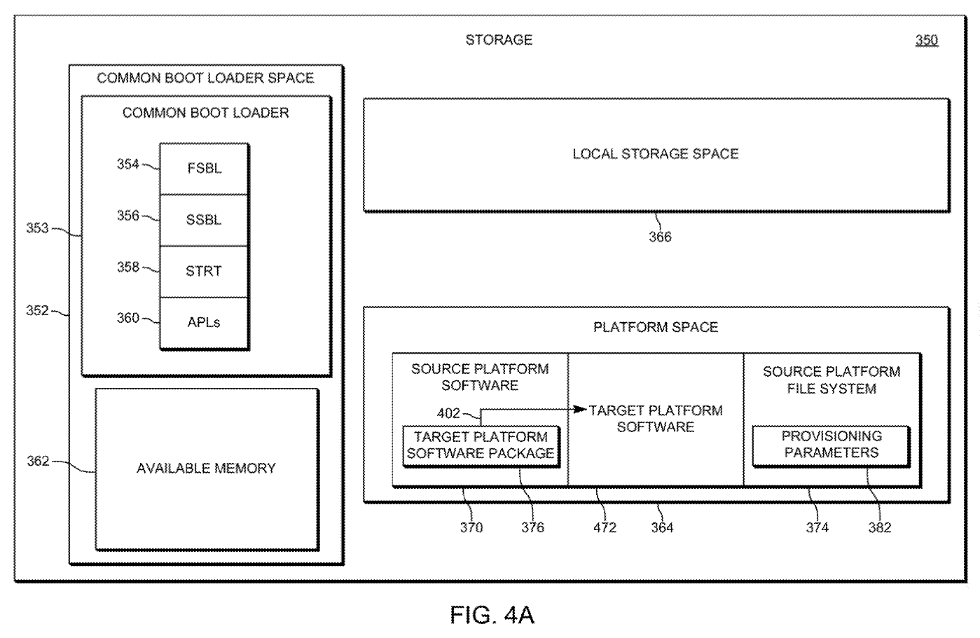

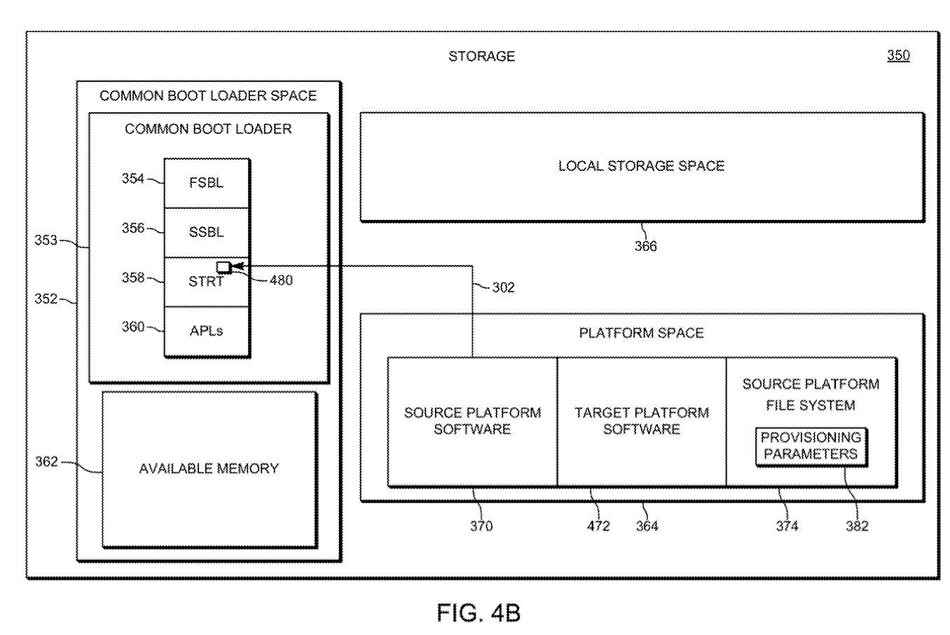

FIGS. 4A and 4B illustrate upgrading a start loader in a common boot loader of a set-top box in accordance with an embodiment of the invention. As illustrated in FIG. 4A, a target platform software 472 has been loaded into the platform space 364. Before the target platform software can be loaded into the platform space, the source platform software 370 receives a target platform software package 376 that contains the target platform software and/or a transition component. The software package may be wrapped in a format readable by the source platform software, which allows the source platform to recognize and authenticate the target platform software before deploying the target platform software into the platform space, as indicated by arrow 402.

In addition to recognizing, authenticating, and loading the target platform software into the platform space, the source platform upgrades the start loader of the common boot loader to include the transition component. In an embodiment, the transition component is implemented as a software program that consists of computer instructions native to and executed by a CPU or processor, such as the CPU 216 described with reference to FIG. 2. In another embodiment, the transition component can be implemented as a software program executed by an interpreter in a virtual computing system. As illustrated in FIG. 4B, the source platform software 370 upgrades the start loader 358 of the common boot loader 353 to include the transition component 380, as indicated by arrow 302. Thus, when the common boot loader executes the start loader to initialize the target platform software 472, the transition component will be executed as well. Note, that once the start loader has been upgraded to include the transition component, future transitions may be performed without upgrading the start loader. In an embodiment, the start loader is further upgraded with a module (not shown) that allows the start loader to understand the file system format used by the source platform.

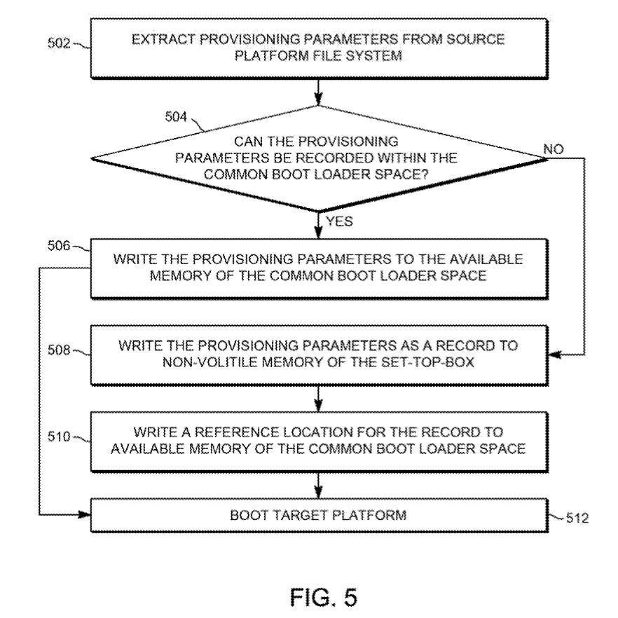

Once the start loader has been upgraded to include the transition component 480, the common boot loader 353 executes to initialize the target platform software 472. When the start loader of the common boot loader is executed, the transition component is also executed. FIG. 5 is a flow chart diagram of a technique for extracting and recording provisioning parameters from a source platform file system by a transition component in a start loader of a common boot loader in accordance with an embodiment of the invention. At block 502, the transition component extracts provisioning parameters from the source platform file system. In an embodiment, the transition component is configured to understand data structure formats of the source platform. The transition component is further configured with locations of provisioning parameters in the source platform file system. That is, locations of data structures from which the provisioning parameters can be extracted. In an embodiment, the locations are identified by offsets. At decision point 504, it is determined whether the extracted provisioning parameters can be recorded within the common boot loader space. For example, extracted provisioning parameters can be recorded within the common boot loader space if the size of the provisioning parameters are less than the size of the available memory in the common boot loader space. For example, the transition component may extract provisioning parameters from the source platform that require 3 MB of space in raw format. In an example, available memory within a common boot loader is 5 MB. Accordingly, at block 506, the transition component writes the provisioning parameters to the available memory of the common boot loader space. In an embodiment, the provisioning parameters are recorded in raw format (e.g., data stripped of metadata for a particular platform file system) so that the provisioning parameters can be read by any platform. Alternatively, at block 508, if, for example, the transition component extracts 7 MB of provisioning parameters (in raw format), then the provisioning parameters will not fit within the available memory of the common boot loader space. Instead, the provisioning parameters can be recorded at a memory location outside of the common boot loader space and, at block 510, a reference pointer to the location of the provisioning parameters is written to the available memory of the common boot loader space. In an embodiment, the memory location outside of the common boot loader space can be memory space that is not allocated to a platform file system. For example, the provisioning parameters can be recorded in a portion of non-volatile memory reserved for writing the provisioning parameters (e.g., a partition of non-volatile memory that is not reformatted during platform transitions) and the reference pointer can indicate the reserved memory. In an embodiment, the reference pointer indicates a memory address by a memory offset, a URL, or by another referencing technique. In another embodiment, the memory location outside of the common boot loader space can be memory space in a network storage location, such as a cloud storage location, or memory space in a remote set-top box on a local area network, but other memory locations could be used as well. In other embodiments, the provisioning parameters can be concurrently recorded, either in part of in full, in the available memory of the common boot loader, the memory location outside of the common boot loader space, and/or the memory space in a network storage location. At block 512, the target platform software is booted and control transfers to the target platform software.

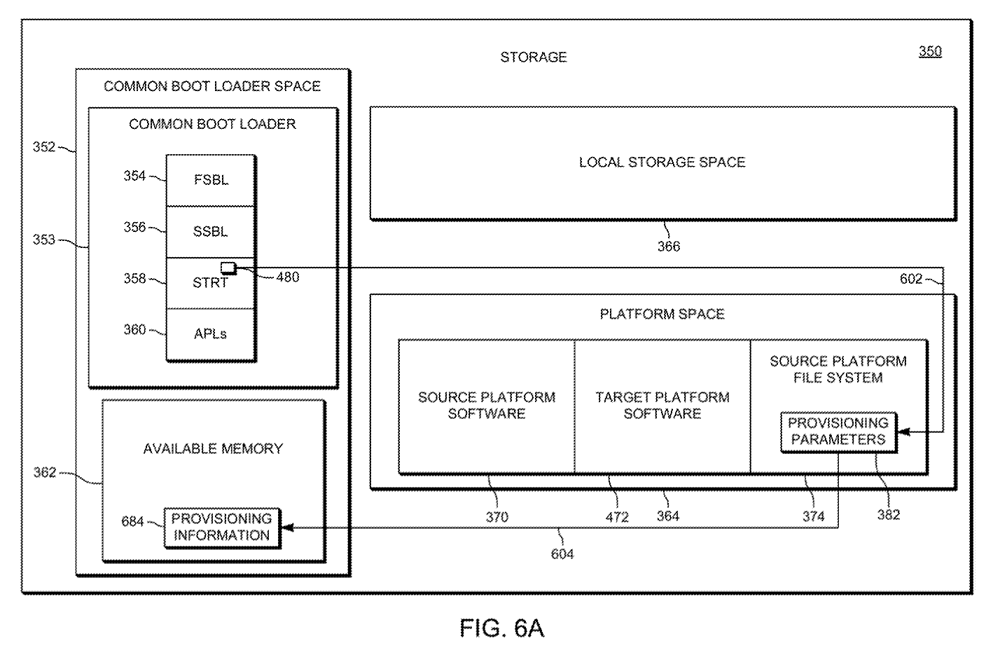

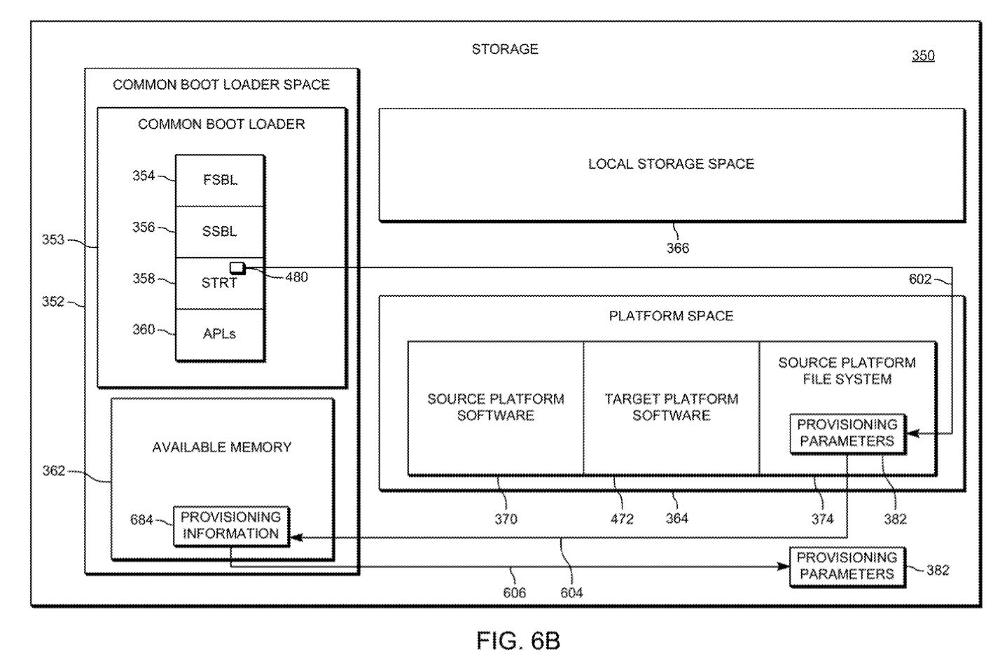

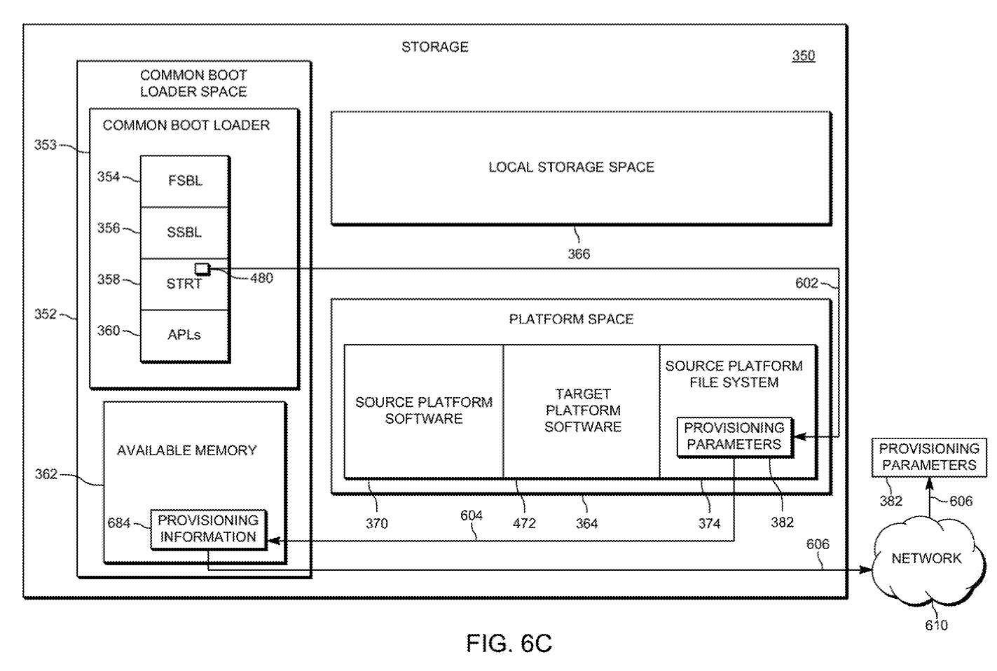

FIGS. 6A-6C illustrate a technique of extracting and recording provisioning parameters from a source platform file system using a transition component in an upgraded start loader of the common boot loader in accordance with an embodiment of the invention. In FIG. 6A, the common boot loader 353 initializes and then executes the transition component 480. The transition component reads the source platform file system 374 (as indicated by arrow 602), extracts provisioning parameters 382 from the source platform file system, and records the extracted provisioning parameters in the available memory 362 of the common boot loader space 352 (as indicated by arrow 604). In an embodiment, the provisioning parameters can be recorded in raw data format and can be used when provisioning the target platform software 472. Alternatively, if the extracted provisioning parameters are too large to record in the available memory of the common boot loader space, then, as illustrated in FIG. 6B, the transition component 480 can read the source platform file system 374, as indicated by arrow 602, and a reference pointer (not shown) can be recorded in the available memory 362 of the common boot loader space 352 as provisioning information 684, as indicated by arrow 604. The provisioning parameters 382 can be recorded outside of the platform space 364 within the storage 350 of the set-top box at a memory location pointed to by the reference pointer, as indicated by arrow 606. In a third alternative, as illustrated in FIG. 6C, the transition component 480 can read the source platform file system 374, as indicated by arrow 602, and a reference pointer (not shown) can be recorded in the available memory 362 of the common boot loader space 352 as provisioning information 684, as indicated by arrow 604. The provisioning parameters 382 can be recorded in memory at a location outside of the set-top box that is connected via a network 610 pointed to by the reference pointer, as indicated by arrow 606.

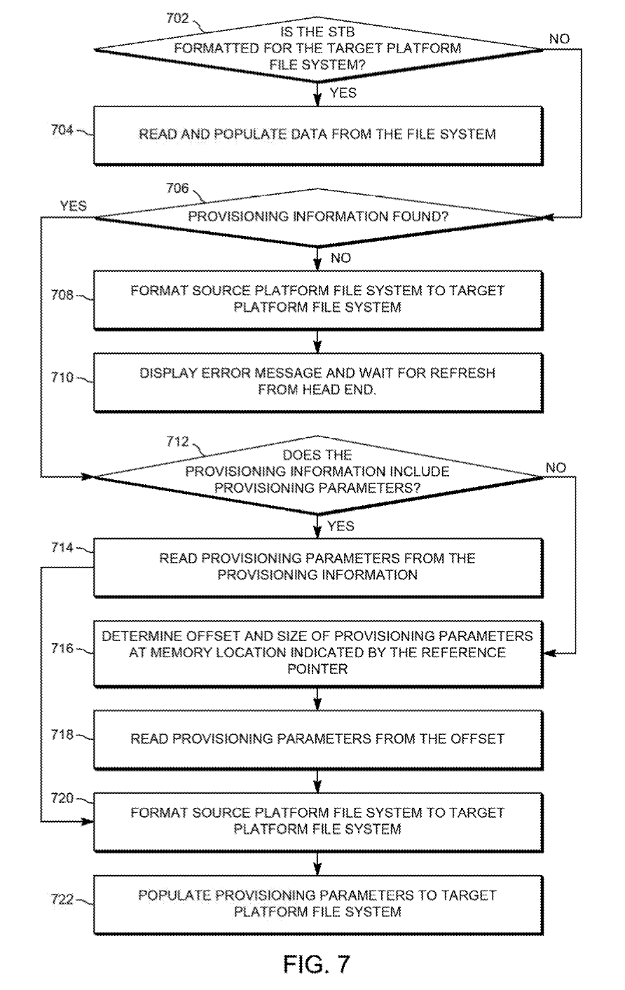

Once control is transferred to the target platform software, the provisioning information in the available memory of the common boot loader space can be used to populate the target platform file system. FIG. 7 is a flow chart diagram of a technique for populating provisioning parameters in the target platform file system in accordance with an embodiment of the invention. At decision point 702, a check is performed to determine if the set-top box is formatted for the target platform file system. In an embodiment, the check is performed by a target transition component in the transition component. The target transition component can be implemented by a software program configured to attempt a write using a file system interface, which would fail if the set-top box is not formatted for the target platform file system. If the set-top box is already formatted, then, at block 704, the target platform software is executed and provisioning data is read from the target platform file system. If the set-top box is not formatted for the target platform file system, then, at decision point 706, a check is performed to determine if the common boot loader space contains provisioning information. At block 708, if no provisioning information is found in the available memory of the common boot loader space, then the source platform file system is formatted to the target platform file system and, at block 710, an error message is displayed while the set-top box waits for a refresh from a head-end to restore provisioning parameters needed for the operation of the set-top box. Additionally, once operation of the set-top box is restored, user parameters will need to be reentered. If provisioning information is found, then, at decision point 712, a check is performed to determine if the provisioning information includes provisioning parameters or if the provisioning information includes a reference pointer to a memory location outside of the common boot loader space. If the provisioning information includes provisioning parameters, then, at block 714, the provisioning parameters are read from the provisioning information. If the provisioning information includes a reference pointer, then, at block 716, the reference pointer is used to determine an offset and a size of memory outside of the common boot loader space in which the provisioning parameters are recorded. At block 718, the provisioning parameters are read from the determined memory location and formatted to the format of the target platform. At block 720, once the provisioning parameters have been read, the source platform file system is formatted to the target platform file system and, at block 722, the target platform file system is populated with the provisioning parameters.

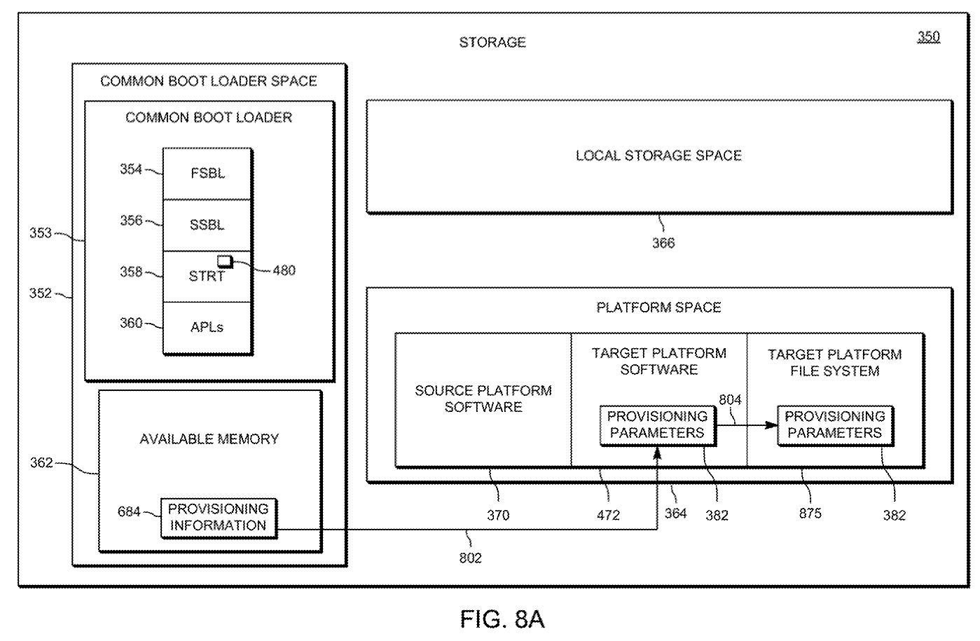

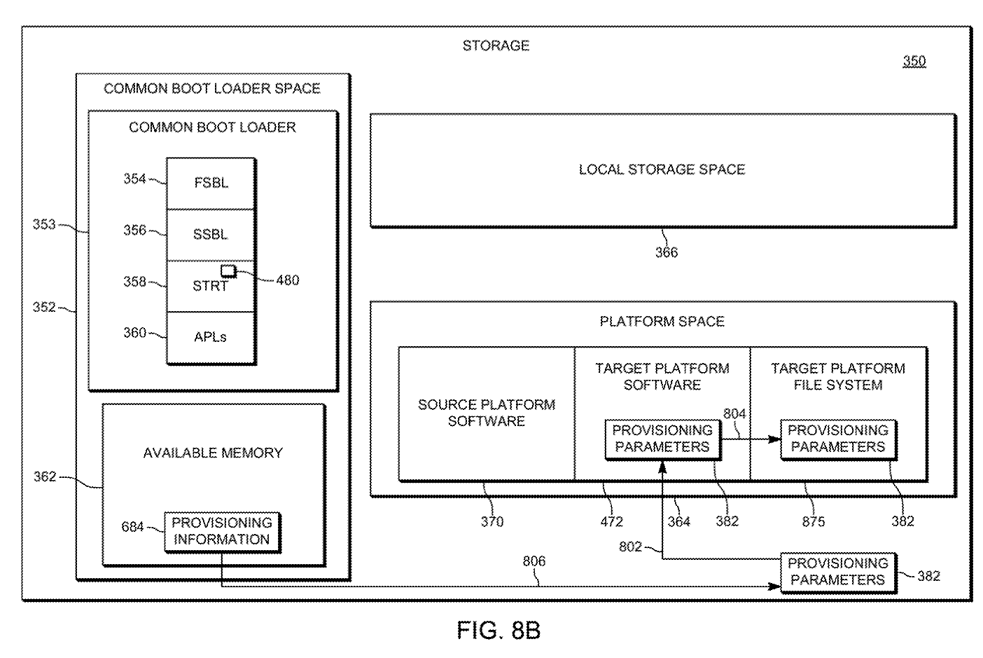

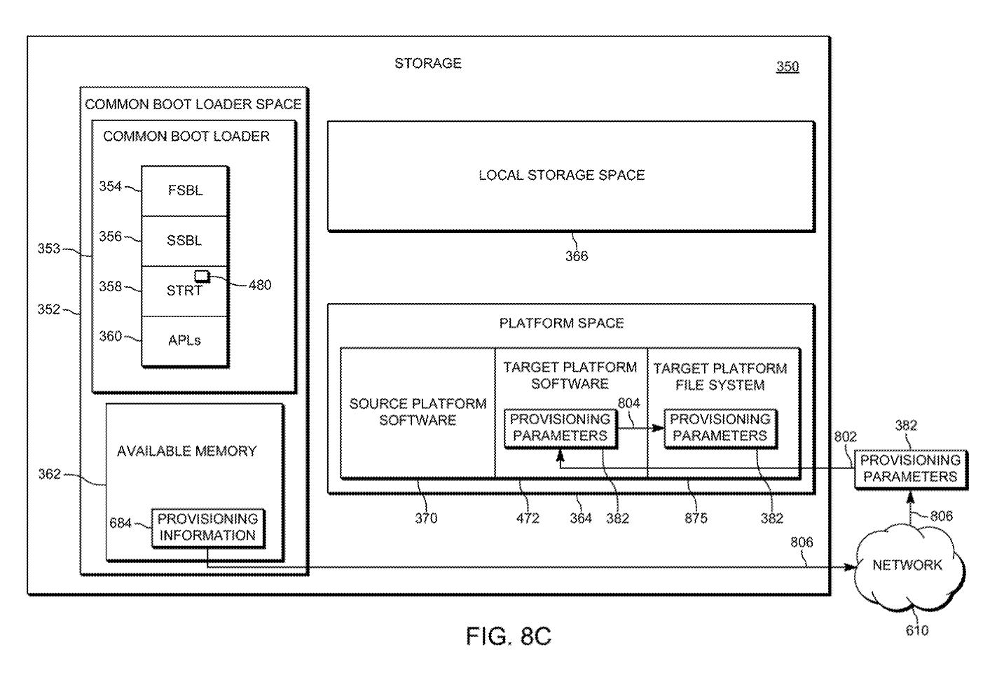

FIGS. 8A-8C illustrate populating provisioning parameters in the target platform file system. In FIG. 8A, the provision parameters 382 are recorded in the available memory 362 of the common boot loader space 352. The target platform software 472 reads the provisioning parameters from the provisioning information 684 recorded in the available memory of the common boot loader space (as indicated by arrow 802), formats the provisioning parameters in the format of the target platform and, as indicated by arrow 804, copies the formatted provisioning parameters into the target platform file system 875. In FIG. 8B, the provisioning information 684 recorded in the available memory 362 of the common boot loader space 352 contains a reference pointer (not shown) to a memory location outside of the platform space 364. As illustrated in FIG. 8B, the target platform software reads the reference pointer from the available memory of the common boot loader space, follows the reference pointer to the indicated memory location (as indicated by arrow 806), and reads the provisioning parameters 382 from the memory location indicated by the reference pointer, as indicated by arrow 802. In an embodiment, the memory location of the provisioning parameters is identified by an offset relative to the platform space. The target platform software then formats the provisioning parameters into the format of the target platform and, as indicated by arrow 804, copies the formatted provisioning parameters into the target platform file system 875. In FIG. 8C, the provisioning information 684 recorded in the available memory 362 of the common boot loader space 352 contains a reference pointer (not shown) to a memory location at a network storage location outside of the set-top box and connected via a network 610. As illustrated in FIG. 8C, the target platform software reads the reference pointer from the available memory of the common boot loader space, follows the reference pointer to the indicated memory location where the provisioning parameters 382 are recorded (as indicated by arrows 806), and reads the provisioning parameters from the memory location at the network storage location, as indicated by arrow 802. In an embodiment, the memory location of the provisioning parameters is identified by an offset relative to a memory address in the network storage location. The target platform software then formats the provisioning parameters into the format of the target platform and, as indicated by arrow 804, copies the formatted provisioning parameters into the target platform file system 875.

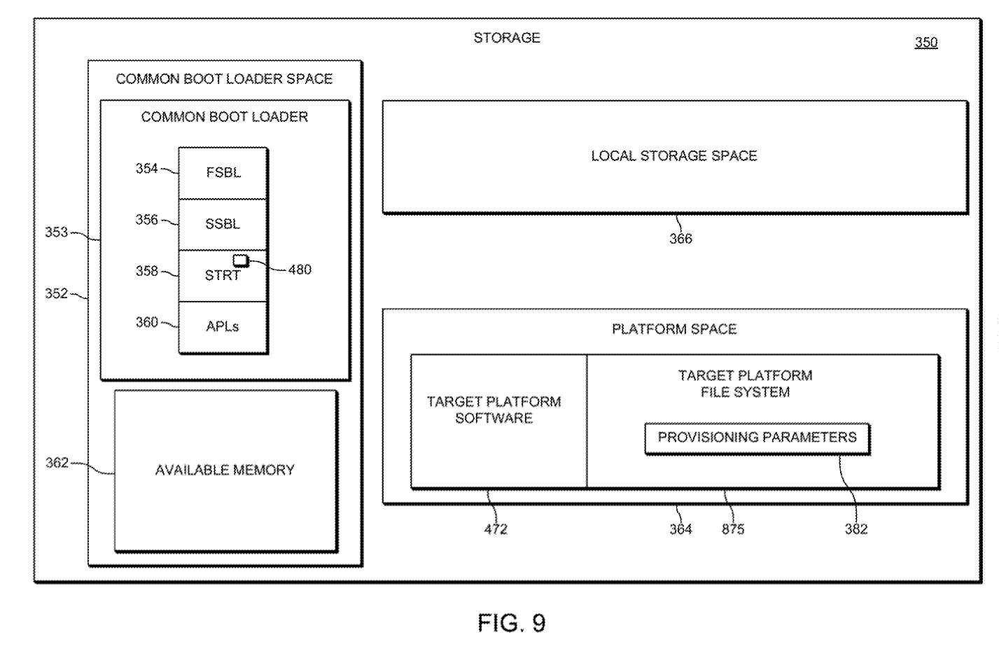

Once the provisioning parameters have been copied into the target platform file system, the target platform software performs a clean-up operation in which the provisioning information, provisioning parameters, and source platform software are removed from the storage 350. FIG. 9 illustrates the state of the storage of a set-top box after a clean-up operation in accordance with an embodiment of the invention. As illustrated, the start loader 358 remains upgraded to include the transition component 480 and the target platform file system 875 is populated with the provisioning parameters 382, which can be read by the target platform software 472. The provisioning information is cleared from the available memory 362 of the common boot loader space 352, the source platform software is cleared from the platform space 364, and provisioning parameters (either in the common boot loader space or outside of the common boot loader space, but not in the target platform file system) are cleared.

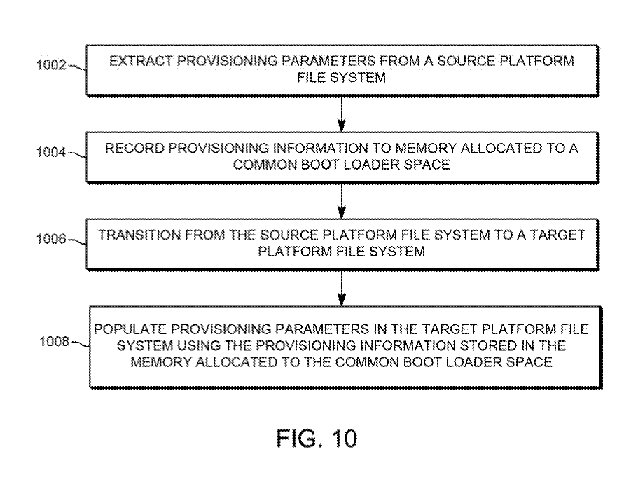

FIG. 10 is a flow chart diagram of a technique for transitioning a set-top box from one platform to another in accordance with an embodiment of the invention. At block 1002, provisioning parameters are extracted from a source platform file system. At block 1004, provisioning information is recorded to memory allocated to a common boot loader space. In an embodiment, provisioning information includes at least one of a reference pointer to the extracted provisioning parameters and the extracted provisioning parameters. At block 1006, the set-top box transitions from the source platform file system to a target platform file system. At block 1008, provisioning parameters are populated in the target platform file system using the provisioning information stored in the memory allocated to the common boot loader space.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a non-transitory computer-readable storage medium for execution by a computing device. As an example, an embodiment of a computer program product includes a non-transitory computer-readable storage medium to store a computer readable program that, when executed on a computing device, causes the computing device to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method for transitioning a set-top box from one platform to another platform, the method comprising:
extracting provisioning parameters from a source platform file system;
recording provisioning information to memory allocated to a common boot loader space, wherein the provisioning information comprises at least one of a reference pointer to the extracted provisioning parameters and the extracted provisioning parameters;
transitioning from the source platform file system to a target platform file system; and
populating provisioning parameters in the target platform file system using the provisioning information stored in the memory allocated to the common boot loader space.

2. The method of claim 1, wherein prior to extracting provisioning parameters, upgrading a start loader of a common boot loader to include a transition component, the transition component configured to perform the extracting and recording.

3. The method of claim 2, wherein the start loader is further upgraded with a module that allows the start loader to understand the source platform file system.

4. The method of claim 2, wherein the transition component is configured with locations of provisioning parameters in the source platform file system and is configured to understand data structure formats of the source platform file system.

5. The method of claim 4, wherein the locations of provisioning parameters are identified by offsets.

6. The method of claim 1, wherein the extracted provisioning parameters are recorded in raw format.

7. The method of claim 1, wherein populating provisioning parameters comprises formatting provisioning parameters into the format of the target platform file system.

8. The method of claim 1, wherein transitioning comprises reformatting the source platform file system to the target platform file system.

9. The method of claim 1, wherein if the provisioning information comprises a reference pointer to the extracted provisioning parameters, then provisioning parameters in the target platform file system are populated with the extracted provisioning parameters stored at a memory location indicated by the reference pointer.

10. The method of claim 9, wherein the memory location indicated by the reference pointer is a memory location in at least one of a portion of non-volatile memory reserved for writing provisioning parameters, a wide area network (WAN) storage location, and a local area network (LAN) storage location;
wherein the reserved memory is preserved when transitioning from the source platform file system to the target platform file system.

11. A non-transitory computer-readable storage medium comprising instructions that, when executed in a computing device, cause the computing device to carry out steps for transitioning a set-top box from one platform to another platform, the steps comprising:
extracting provisioning parameters from a source platform file system;
recording provisioning information to memory allocated to a common boot loader space, wherein the provisioning information comprises at least one of a reference pointer to the extracted provisioning parameters and the extracted provisioning parameters;
transitioning from the source platform file system to a target platform file system; and
populating provisioning parameters in the target platform file system using the provisioning information stored in the memory allocated to the common boot loader space.

12. The non-transitory computer-readable storage medium of claim 11, wherein prior to extracting provisioning parameters, upgrading a start loader of a common boot loader to include a transition component, the transition component configured to perform the extracting and recording.

13. The non-transitory computer-readable storage medium of claim 12, wherein prior to extracting provisioning parameters, upgrading the start loader with a module that allows the start loader to understand the source platform file system.

14. The non-transitory computer-readable storage medium of claim 12, wherein the transition component is configured with locations of provisioning parameters in the source platform file system and is configured to understand data structure formats of the source platform file system.

15. The non-transitory computer-readable storage medium of claim 14, wherein the locations of provisioning parameters are identified by offsets.

16. The non-transitory computer-readable storage medium of claim 11, wherein the extracted provisioning parameters are recorded in raw format.

17. The non-transitory computer-readable storage medium of claim 1, wherein populating provisioning parameters comprises formatting provisioning parameters into the format of the target platform file system.

18. The non-transitory computer-readable storage medium of claim 11, wherein transitioning comprises reformatting the source platform file system to the target platform file system.

19. A set-top box comprising a processor and memory, wherein the memory comprises instructions that, when executed by the processor, perform steps comprising:
extracting provisioning parameters from a source platform file system;
recording provisioning information to memory allocated to a common boot loader space, wherein the provisioning information comprises at least one of a reference pointer to the extracted provisioning parameters and the extracted provisioning parameters;
transitioning from the source platform file system to a target platform file system; and
populating provisioning parameters in the target platform file system using the provisioning information stored in the memory allocated to the common boot loader space.
